(19) United States
(12) Patent Application Publication
(10) Pub. No.: US 2005/0232530 A1
(43) Pub. Date: Oct. 20, 2005

(54) Electronically controlled volume phase grating devices, systems and fabrication methods

(76) Inventor: Jason Kekas, Raleigh, NC (US)

Correspondence Address: MYERS BIGEL SIBLEY & SAJOVEC, PO BOX 37428, RALEIGH, NC, 27627, US

(21) Appl. No.: 11/092,112

(22) Filed: Mar. 29, 2005

Related U.S. Application Data
(60) Provisional application No. 60/558,764, filed on Apr. 1, 2004.

(51) Int. Cl. G02B 6/00

(52) U.S. Cl. 385/11

(57) ABSTRACT

Electrically controlled volume phase gratings and electrically controlled Bragg Gratings can provide variable diffraction gratings that can be operated in a transmissive and/or reflective mode. They can be made from electro-optic materials placed directly on glass or semiconductor materials, utilizing conventional Liquid Crystal on Silicon (LCOS) processes and equipment. Highly efficient and/or small device form factors may be provided.

### CROSS-REFERENCE TO RELATED APPLICATION

This application claims the benefit of Provisional Application No. 60/558,764, filed Apr. 1, 2004, entitled Electronically Controlled Volume Phase Grating Devices, Systems and Fabrication Methods, the disclosure of which is hereby incorporated herein by reference in its entirety as if set forth fully herein.

### FIELD OF THE INVENTION

This invention relates to optical devices and fabrication methods therefor, and more specifically to electronically controlled optical devices and fabrication methods therefor.

### BACKGROUND OF THE INVENTION

Projection Technologies for Microprojection

While several emissive display technologies (CRT, LCD, Plasma, etc.) have been the mainstay of the display market, they may be bulky, expensive and/or may not scale well. Microprojection display technologies also have been developed. Microprojection technologies may fall into two basic types: transmissive and reflective. Transmissive devices may include Liquid Crystal Displays (LCD) and Cathode Ray Tube (CRT) based projectors. Reflective technologies include MEMs based micro-mirror devices, Grating Light Valves (GLV) and Liquid Crystal on Silicon (LCOS). These microprojection technologies will be briefly described.

LCD

An LCD may be found in many laptop displays and in a growing number of flat panel displays for use as monitors and small screen TVs. As shown in FIG. 1, an LCD can include two crossed polarizers with a layer of liquid crystals in between and with a red, green or blue filter allowing for full color. With an LCD, unpolarized light is passed through a polarizer to create linearly polarized light. That light is then passed through the liquid crystal layer to rotate its polarization in varying degrees from an applied electric potential. The light rotated in the crystal layer is then passed through the second polarizer. If the polarization of the light and the second polarizer are in the same direction, the light will pass through and result in a pixel that is in the “ON” state. If they are in opposite directions, light will be blocked and will appear to be in the off state. While these devices may be low cost because of volume production, they may have poor contrast due to inter-pixel spacing, transistor placement and/or light absorption.

CRT

Like conventional TVs, some projectors may have smaller CRT tubes built into them. These tubes may be small (perhaps 9-inch diagonal), may be expensive and can be extremely bright. In the basic layout, one or more CRT tubes form the images. A lens in front of the CRT magnifies the image and projects it onto the screen. Three CRT configurations may be used in CRT projectors:
One color CRT tube (red, blue, green phosphors) displays an image with one projection lens.
One black-and-white CRT with a rapidly rotating color filter wheel (red, green, blue filters) is placed between the CRT tube and the projection lens. The rapid succession of color images projected onto the screen forms an apparently single color image.
Three CRT tubes (red, green, blue) with three lenses project the images. The lenses are aligned so that a single color image appears on the screen.

One of the potential problems with CRT projectors is that, with anywhere from one to three tubes and accompanying lenses and/or a filter wheel built in, the projectors can be quite heavy and large. Also, CRT devices may not have the fine resolution that LCD devices do, especially when projected.

MEMs—Tilting Mirror

Traditional optical microelectromechanical system (MEMS) structures can be true micro-machines that incorporate actual mechanical components such as mirrors mounted on some form of a mechanical bearing device. Source light is reflected as a mirror sweeps across an arc, sending light from one location to another. See FIG. 2. In many tilting mirror designs, the MEMS device is etched out of a silicon substrate, with the control surface coated with a reflective material such as gold or aluminum, leaving a mirror on a bearing surface. In order to allow mechanical clearance to sweep a mirror of adequate size over a suitable range of angles, the mirror surface and supporting hinges or gimbals often are “lifted up” off the surface of the silicon, and may use complex self-assembly techniques. The movement and positioning of the mirror may use precise control electronics and accurate feedback mechanisms. In operation, this type of device will switch light from one direction to the other.

MEMs—Diffraction Grating

Another type of optical MEMS device is an optical MEMS based on an addressable diffraction grating. For example, Silicon Light Machines' Grating Light Valve (GLV) device utilizes the principle of diffraction to switch, attenuate and modulate light. This type of device is a dynamic diffraction grating that can serve as a simple mirror in the static state, or a variable grating in the dynamic state. See FIG. 3. This approach offers potential advantages in terms of speed, accuracy, and reliability over the common “tilting mirror” MEMS structures. While these may be easier to make than traditional MEMS mirrors, they are still MEMS devices that can have low yields and may be difficult and expensive to make. This type of MEMS structure also may require a rotating mirror for correct operation.

LCOS

Liquid crystal on silicon (LCOS) is similar to the technology used in laptop displays. An LCOS light valve also uses polarization, with a polarizing beam splitter being the equivalent of two crossed polarizers. With the LCOS device, unpolarized light is passed through a polarizing beam splitter to give linearly polarized light. That light then reflects off the LCOS device to rotate the light polarization in varying degrees from an applied electric potential. In the reverse direction the beam splitter acts as the second crossed polarizer. See FIG. 4. This device may be very inefficient and frequently requires three light valves for imaging Red, Green, and Blue.

### SUMMARY

Electrically controlled volume phase gratings and electrically controlled Bragg Gratings, according to embodiments of the invention, can provide variable diffraction gratings that can be operated in a transmissive and/or reflective mode. They can be made from electro-optic materials placed directly on glass or semiconductor materials, utilizing conventional Liquid Crystal on Silicon (LCOS) processes and equipment. Highly efficient and/or small device form factors may be provided. Due to their potential high efficiency and potential low cost, these optical shutters can be placed close together to fabricate an integrated, high resolution imager that can be up to 2-4 times or more efficient than standard LCOS microdisplays. Scalable, high resolution displays thereby may be provided. Embodiments of the invention may be used in integrated micro-projection systems for laptops and gaming devices, front and rear projection HDTV, Heads-up displays, digital art, and/or many other consumer, commercial and/or other applications.

### BRIEF DESCRIPTION OF THE DRAWINGS

FIG. 1 illustrates a conventional LCD.

FIG. 2 illustrates a conventional tilting mirror optical MEMS device.

FIG. 3 illustrates a conventional grating light valve (GLV).

FIG. 4 illustrates a conventional liquid crystal on silicon (LCOS) device.

FIGS. 5A and 5B illustrate diffraction of a reflective grating and a transmissive grating, respectively, according to exemplary embodiments of the present invention.

FIG. 6 illustrates a dynamic phase element, according to exemplary embodiments of the present invention.

FIG. 7 illustrates a fixed phase element, according to exemplary embodiments of the present invention.

FIGS. 8A and 8B illustrate a single off DLS device and a single on DLS device, respectively, according to exemplary embodiments of the present invention.

FIG. 9 illustrates multiple diffraction orders, according to exemplary embodiments of the present invention.

FIG. 10 graphically illustrates intensity and orders of diffraction, according to exemplary embodiments of the present invention.

FIG. 11 illustrates how a majority of light may be diffracted into the first orders, according to exemplary embodiments of the present invention.

FIG. 12 illustrates a shutter/switch in OFF mode, according to exemplary embodiments of the present invention.

FIG. 13 illustrates a shutter/switch in ON mode, according to exemplary embodiments of the present invention.

FIG. 14 illustrates a shutter/switch in variable mode, according to exemplary embodiments of the present invention.

FIG. 15 illustrates output of an ON dot, according to exemplary embodiments of the present invention.

FIG. 16 illustrates output of an OFF dot, according to exemplary embodiments of the present invention.

FIG. 17 illustrates possible dot patterns, according to exemplary embodiments of the present invention.

FIGS. 18A and 18B illustrate rectangular pixel shapes and octagonal pixel shapes, respectively, according to exemplary embodiments of the present invention.

FIGS. 19A and 19B illustrate HPDLC-transmissive devices, according to exemplary embodiments of the present invention.

FIGS. 20A-20F illustrate HPDLC-reflective devices, according to exemplary embodiments of the present invention.

FIGS. 21A and 21B illustrate LC/blazed grating-transmissive devices, according to exemplary embodiments of the present invention.

FIGS. 22A-22C illustrate LC/blazed grating-reflective devices, according to exemplary embodiments of the present invention.

FIG. 23 illustrates active Bragg stack and reflective blazing gratings, according to exemplary embodiments of the present invention.

FIG. 24 illustrates active Bragg stack and mirrors, according to exemplary embodiments of the present invention.

FIG. 25 and 25A illustrate LC/blazed grating-bulk prototypes, according to exemplary embodiments of the present invention.

FIGS. 26A and 26B illustrate Bragg stack notch filter operation and Bragg stack shift operation, respectively, according to exemplary embodiments of the present invention.

FIGS. 27A-27C illustrate LC/blazed grating-reflective devices, according to exemplary embodiments of the present invention.

FIG. 28 illustrates fabrication of a master or submaster grating with a release layer and a transfer coating, according to exemplary embodiments of the present invention.

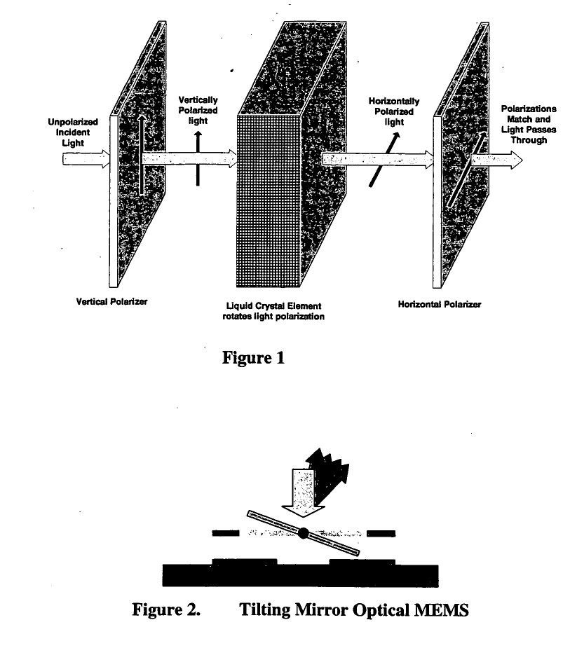

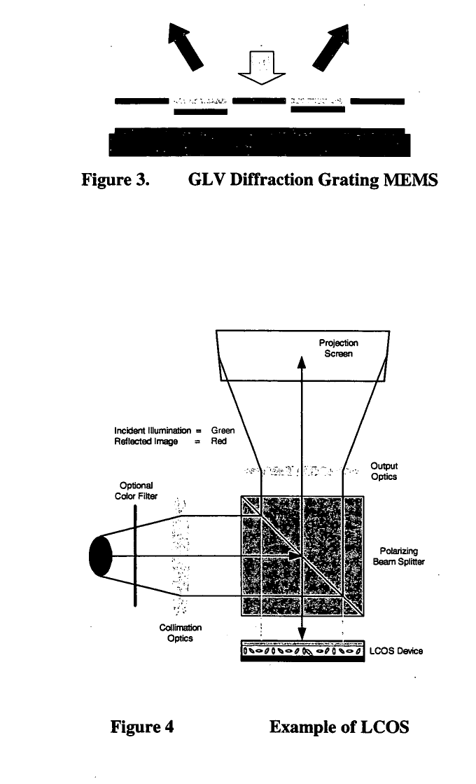

### DETAILED DESCRIPTION

The present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element such as a layer, region or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

It will be understood that if part of an element, such as a surface, is referred to as “outer,” it is closer to the outside of the device than other parts of the element. Furthermore, relative terms such as “beneath” or “above” may be used herein to describe a relationship of one layer or region to another layer or region relative to a substrate or base layer as illustrated in the figures. It will be understood that these terms are intended to encompass different orientations of the device in addition to the orientation depicted in the figures.

Furthermore, relative terms, such as “lower” and “upper”, may be used herein to describe one element's relationship to another element as illustrated in the figures. It will be understood that relative terms are intended to encompass different orientations of the device in addition to the orientation depicted in the figures. For example, if the device in the figures is turned over, elements described as being on the “lower” of other elements would then be oriented on “upper” of the other elements. The exemplary term “lower”, can therefore, encompass both an orientation of lower and upper, depending of the particular orientation of the figure.

It will also be understood that although the terms first, second, etc. are used herein to describe various embodiments, elements, regions, layers and/or sections, these regions, embodiments, elements, layers and/or sections should not be limited by these terms. These terms are only used to distinguish one embodiment, element, region, layer or section from another embodiment, element, region, layer or section. Thus, a first embodiment, element, region, layer or section discussed below could be termed a second embodiment, element, region, layer or section, and similarly, a second embodiment, element, region, layer or section may be termed a first embodiment, element, region, layer or section without departing from the teachings of the present invention. Finally, the terms “on” and “off” are used herein to distinguish two binary states of voltage, light or other parameters and do not designate absolute levels of voltage, light or other parameters.

Electronically controlled volume phase grating devices, systems and fabrication methods according to some embodiments of the present invention can potentially provide high performance and/or low cost alternatives to conventional display technologies. Embodiments of the present invention can use digitally controlled optical shutters. Accordingly, some embodiments of the invention may be referred to herein as a Digital Light Switch or “DLS.” Some embodiments of the invention can act as a mirror in the off state and a diffraction grating in the “on” state. Some embodiments of the present invention can provide MEMS-like high performance at the price point of LCOS. Embodiments of the present invention may be used in applications that can range from handheld video flashlights to full size digital theaters.

As will be described in greater detail below, some embodiments of the present invention use Holographically formed Polymer Dispersed Liquid Crystals (HPDLC) in a transmissive and/or reflective mode. Other embodiments of the present invention use Liquid Crystals and Blazed Gratings (LCBG) in transmissive and/or reflective mode. Yet other embodiments of the present invention use an active Bragg stack and a reflective blazed grating. Still other embodiments use an active Bragg stack and a mirror. Other embodiments use combinations and subcombinations of these elements.

Addressable diffraction grating devices thereby may be provided based on these electro-optical materials. The principle of diffraction can be used to switch or modulate light. Some embodiments of the present invention can serve as a simple mirror in the “off” state or a phase grating in the dynamic state. Embodiments of the invention can potentially provide significant functional advantages in terms of speed, accuracy, reliability and/or ease of manufacturing over other technologies. More specifically, when compared with other optical technologies, embodiments of the present invention can offer one or more of the following potential advantages:
1. High optical efficiency.
2. Low cost.
3. Low power consumption.
4. High resolution (scalable to QXGA or higher resolution).
5. Optical angular repeatability that can be permanently set with photolithographic precision.
6. No moving parts—high reliability and stability.
7. Simple to manufacture in conventional semiconductor fabs.
8. Easily integrated with various semiconductor materials and logic families.
9. Pixels can be placed in two dimensional arrays.
10. High speed (KHz operation for LCBG, GHz operation for Electrically controlled Bragg Grating)
   Principles of Operation

Embodiments of the invention are based on diffraction. Diffraction is the macroscopic effect of many coherent light waves interfering together to give the effect of light bending or deviating from the expected direction. This interference is based on the differences in the phase of adjacent light waves as they mix. This is because each wave has its own phase associated with it.

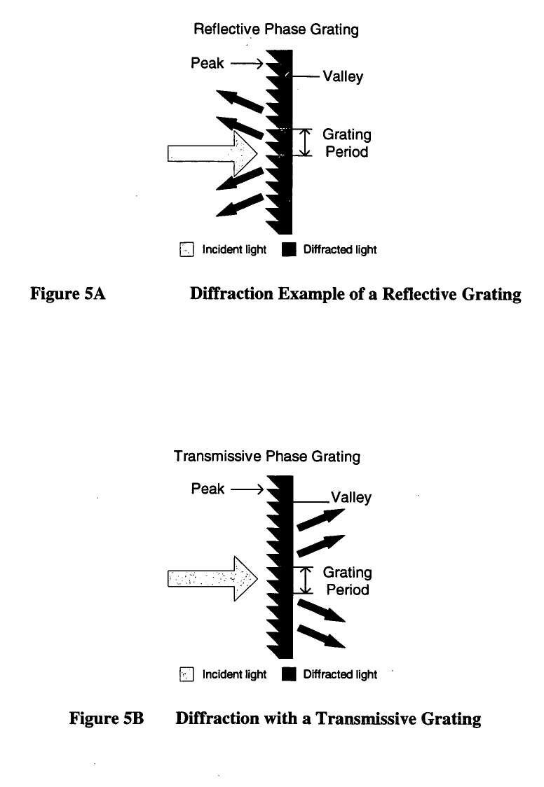

A reflective phase grating is an example of a diffractive device that takes light incident on the grating and shifts its phase such that diffraction occurs. The light that reflects off the peaks of the grating has a different phase relative to the light reflecting off the valleys. The result is that light reflects off the grating specific angles other than if it were reflecting off of a mirror. These diffraction angles (or orders) are proportional to the grating period and wavelength (λ) of the light. FIG. 5A illustrates a reflective diffraction grating. FIG. 5B illustrates a transmissive diffraction grating.

Some embodiments of the invention include multiple periods of dynamic and fixed elements that may be similar to the peaks and valleys of the diffraction gratings in FIGS. 5A and 5B. The dynamic elements operate as though the height of the peaks were variable. The fixed elements, as the name suggests, are like valleys that do not change.

General Operation of Liquid Crystal Based Dynamic Elements

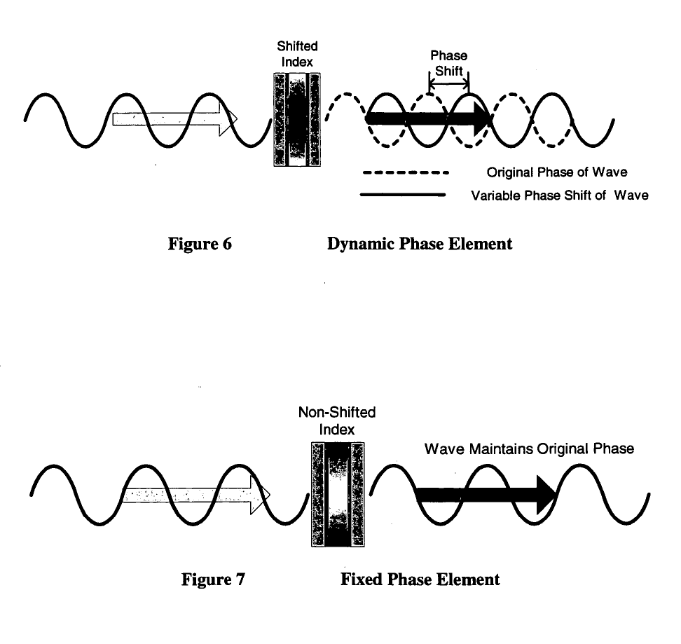

A liquid crystal based, variable or dynamic phase element that may be used in embodiments of the invention is made up of a holographic or blazed phase grating with a liquid crystal layer in, and in some embodiments filling, the valleys of the grating, which is sandwiched between a pixel electrode and a common electrode. The electrodes can either be reflective or transparent based on the desired mode of operation as will be described in detail below. When there is no electric potential across the device, there is a mismatch of the index of refraction of the liquid crystal and the phase grating. In this case, the grating is visible and light is diffracted as it passes through the device. This is from a shift in phase induced by the grating. Consequently, when an electric field potential is induced across the device, the potential causes a change in the effective refractive index of the liquid crystals by reorienting them in reference to the grating so that the effective index of the liquid crystals matches the grating and the grating disappears. If the electric field through the device is zero, then the phase shift is at a maximum and diffraction is at a maximum. As the applied electric field is increased then there is a phase shift or diffraction that is inversely proportional to the increased voltage. See FIG. 6.

In some embodiments, such as the HPDLC devices, the fixed phase elements are also the peaks of the transmission grating. These elements have a fixed index of refraction and no phase shift occurs. See FIG. 7.

Dynamic Diffraction Gratings

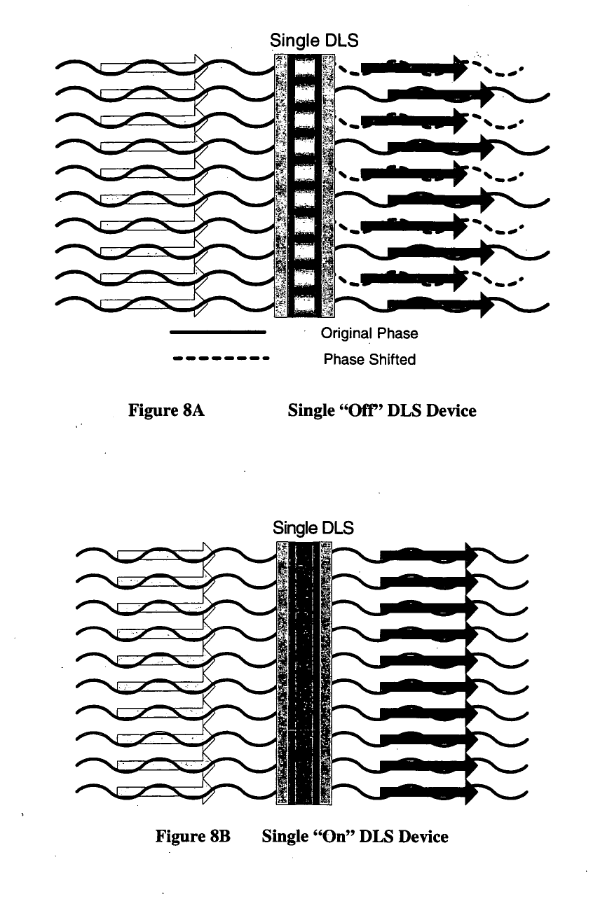

A minimum addressable optical switch element according to some embodiments of the invention provides a dynamic diffraction grating, including a plurality (two or more) grating periods that is spanned by an addressable (patterned or pixel) electrode. Each period has two adjacent phase elements. One is a dynamic phase element and the other is a fixed phase element. Multiple pairs of these elements are placed on a glass or semiconductor substrate to form the grating. In some embodiments, a minimum addressable optical switch element can include five or more grating periods with submicron element widths spanned by an addressable electrode. Depending on the application, the width of the elements and the number of periods in an individual grating may vary. See FIGS. 8A and 8B. Alignment of the grating relative to the addressing electrodes may not be needed because the grating is a much finer pitch or pattern than the patterned addressable electrodes.

Embodiments of the invention may be set to the fully reflecting or transparent state when all elements have the same index of refraction or phase retardation. This occurs by inducing an voltage across the DLS. Embodiments of the invention may be set to the diffracting state by having a zero electric potential across the DLS making the diffraction grating apparent. Some embodiments can be operated with dynamic elements either “on” with no phase shift or “off” with a phase shift.

The first-order diffracted light intensity can be essentially zero when voltage is applied. At least two factors can lead to this result. First, most of the incident light is simply reflected specularly by the device. Second, any potential diffracting features of the intended reflective state may be reduced by coating with an indexed matched glass insulator to prevent any undesirable diffractive effects.

Diffraction Orders

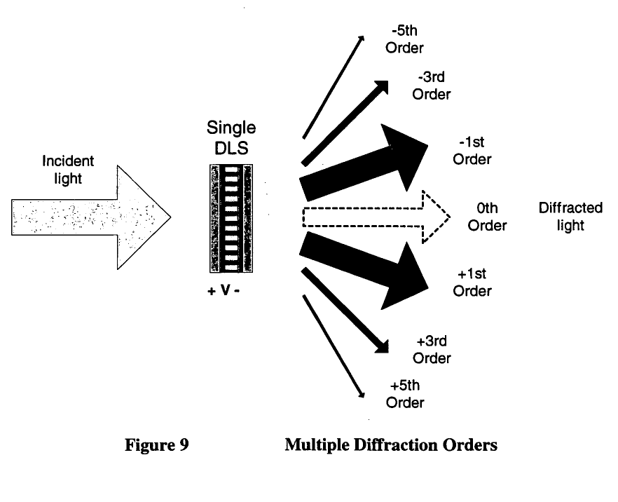

When light is passed through a phase grating, such as embodiments of the invention in the “off” state, the light generally does not follow in a straight line (the 0^{th} order). It is “bent” or diffracted into different diffraction orders. These orders are located at certain specific angles of diffraction. For example, if a sheet of paper is placed after the grating, bright spots would be seen at certain intervals across the sheet. These are the odd numbered orders and the only orders to contain light. The dark areas in between the bright spots, where light seems to be missing are the even numbered orders. See FIG. 9 for an example of the multiple diffraction orders.

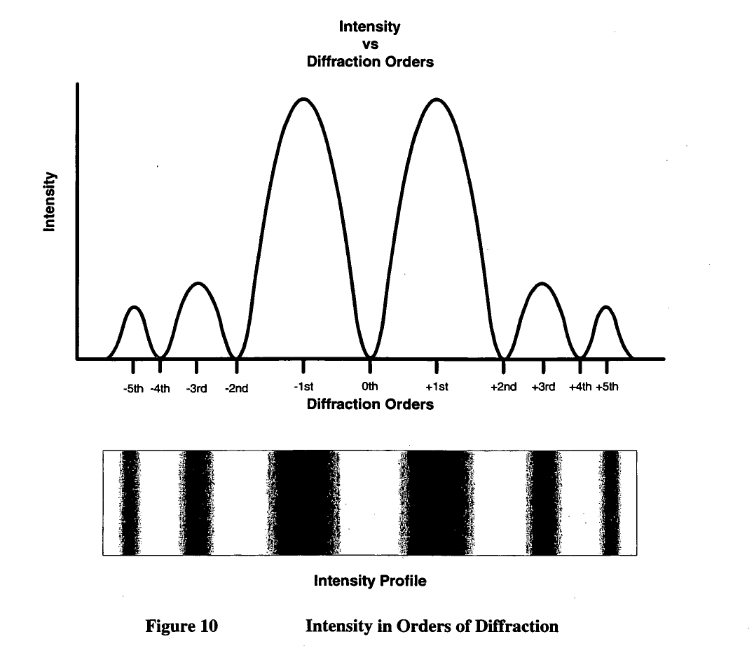

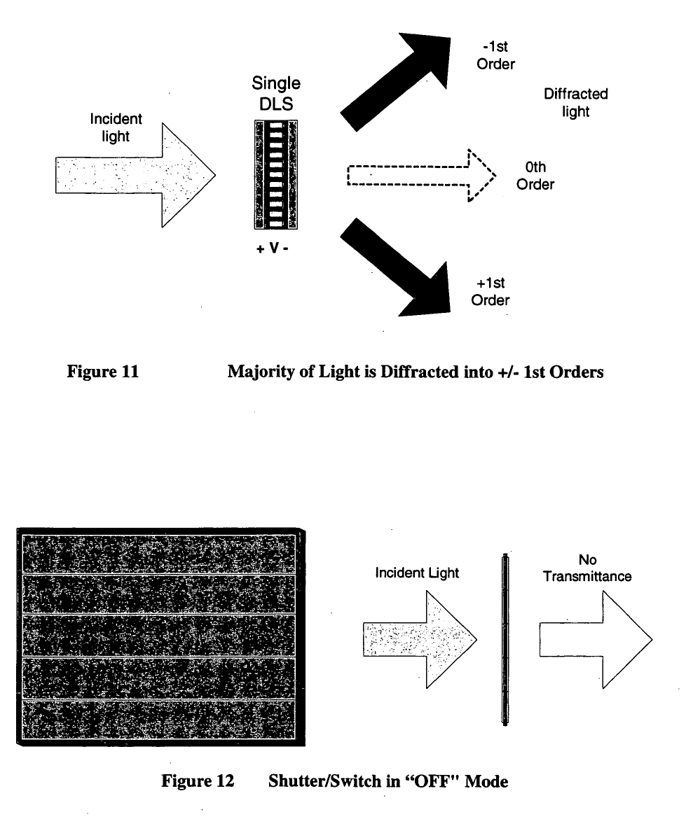

Not all of the light is distributed evenly into the odd numbered orders. For holographic gratings, as can be seen by the graph and intensity profile of FIG. 10, the majority of light is diffracted into the positive and negative 1^{st} orders and then falls off dramatically in the 3^{rd} and 5^{th} orders. In reality, the amount of light in the higher numbered orders may be insignificant and can be ignored. See FIG. 11.

For blazed gratings, the majority of light is diffracted into a single order and the other orders can be ignored.

Switch or Shutter Type Operation

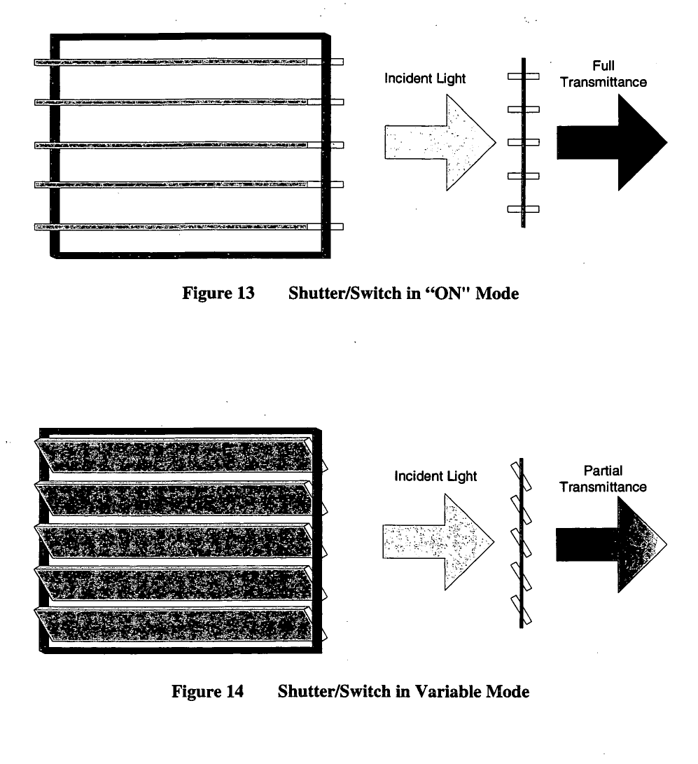

Embodiments of the invention may operate in binary or greyscale modes and can be analogized to a venetian blind or shutter. When the shutter is off or closed, the light does not pass, which means that there is zero light in the 1^{st} orders. See FIG. 12. When the shutter is open or turned on, the light passes into the 1^{st} order. See FIG. 13. Since diffraction does not occur (light does not pass) when the shutter is off, the contrast ratio of on to off can be up to 1000:1 or better in some embodiments. This operation can be anywhere in between to give greyscale mode. See FIG. 14. Conventional system elements may be used to collect the diffracted light and reorient the diffracted light to emerge generally orthogonal to the device.

Methods for greyscale operation can include pulsewidth modulation, a varying electric field potential and/or other techniques.

Pixel Shapes and Patterns

The output shape of the device or dot will be approximately the shape of the device, with a Gaussian profile that can fill the entire shape. If the dot is a rectangle then the output can appear rectangular. If the dot is square then the output can appear square.

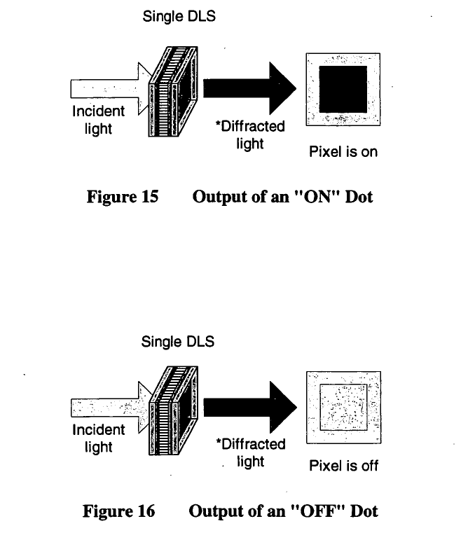

An “on” dot can look filled in. See FIG. 15. An “off” dot can look empty. See FIG. 16.

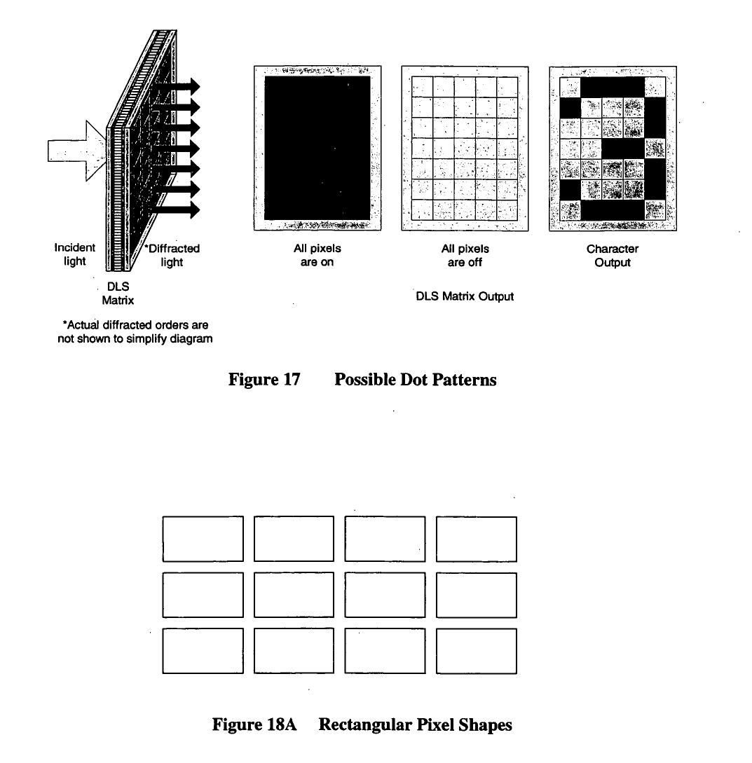

Since dots can be placed in series to form an array, multiple output patterns can be produced. An example would be if all the dots in a multi-pixel array are turned on. The output would be a uniform array that resembles a completely smooth and flat line. Any dot can be turned on or off in any pattern. FIG. 17 shows several example output patterns.

Optical Efficiency

The optical efficiency of devices according to some embodiments of the invention may depend on two main factors: 1) the diffraction efficiency and 2) the reflectivity or transmission of the materials chosen. In an ideal Blazed transmission diffraction grating, 60+% of the diffracted light energy is directed into the 1st order. It can be up to 70%-90% for an ideal blazed reflection grating. Devices according to embodiments of the invention may lie somewhere in between; therefore, 60% can be used as a lower bound. Reflectivity of a reflective layer may depend on the choice of material selected. While some materials can be selected (such as gold), other metal alloys typically used in semiconductor processes allow for cost-effective manufacturing and can have greater than 90% reflectivity over most of the wavelengths used for printing applications. Device efficiency is then the product of diffraction efficiency (60%) and, for example, aluminum reflectivity (typically >91%). Overall, the minimum device efficiency may be around 54%. This can be significantly higher than LCOS. With some embodiments, the efficiencies could be higher than 85%.

High Optical Precision

When no voltage is applied to the DLS, the device is placed in a diffractive state. The source light is then diffracted at set angles, as illustrated, for example, in FIGS. 5, 9 and 11. These diffraction angles may be fixed with photolithographic accuracy when the device is manufactured. Therefore, very precise light placement may be achieved without the need for complex control electronics. This can allow for potentially significantly smaller and potentially less expensive packaging and lower power requirements for optical components and subsystems.

Reliability and Stability

High component reliability is also desirable. The potentially simple design of devices according to embodiments of the invention can be inherently reliable. The elements may be made of well-known and reliable liquid crystals, polymers, and semiconductor materials.

Embodiments of the invention also may be able to withstand extremely high optical power densities. As previously mentioned, these devices may be composed of liquid crystals and/or electro-optic materials. The surrounding substrates and structures may be semiconductor (Si, GaAs, InP) or glass substrates, logic components, and glass insulators. These materials may be very robust in nature.

Devices according to embodiments of the invention may be capable of withstanding optical power levels of greater than 10 MW/cm², with potentially little or no degradation in behavior. This can be due to high optical damage thresholds of many liquid crystal and polymer materials. These numbers may contrast with other technologies that may be limited to power thresholds of 1 MW/cm² or less—which may be several orders of magnitude lower than devices according to embodiments of the invention.

Scalability and Pixel Shape

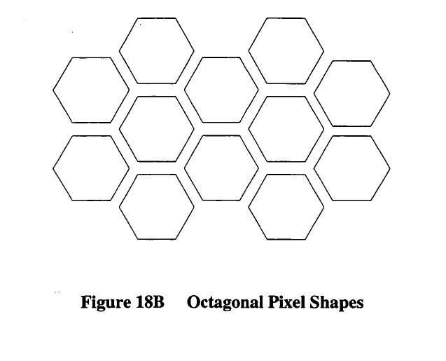

Since standard CMOS processes may be used to create devices according to some embodiments of the invention, the resolution and pixel shape can be scaled to meet the needs of desired applications, whether it be low resolution video flashlights or very high-end movie theater systems. It may be limited only in size and shape by the capabilities of the semiconductor foundry. FIGS. 18A and 18B illustrate various pixel geometries that can be used. Other polygonal, circular, elliptical and/or ellipsoidal shapes may be used.

Ease of Manufacturing

Another potential attribute of embodiments of the invention is the potential ease of manufacturing (including flexible design parameters and very low cost). The devices may be fabricated using standard semiconductor, LCD, and LCOS foundries. They can use only inexpensive electro-optic materials, conventional process steps, and relatively few photolithographic masks.

Integration with Semiconductor Logic

Due to the intrinsic simplicity of the devices and the choice of materials and processes that may be used, the devices can be integrated with standard semiconductor logic circuitry to allow simplified driver and interface electronics. This capability can allow faster feedback response times, lower component costs at volume, higher component reliability, and/or simpler packaging.

### Embodiments

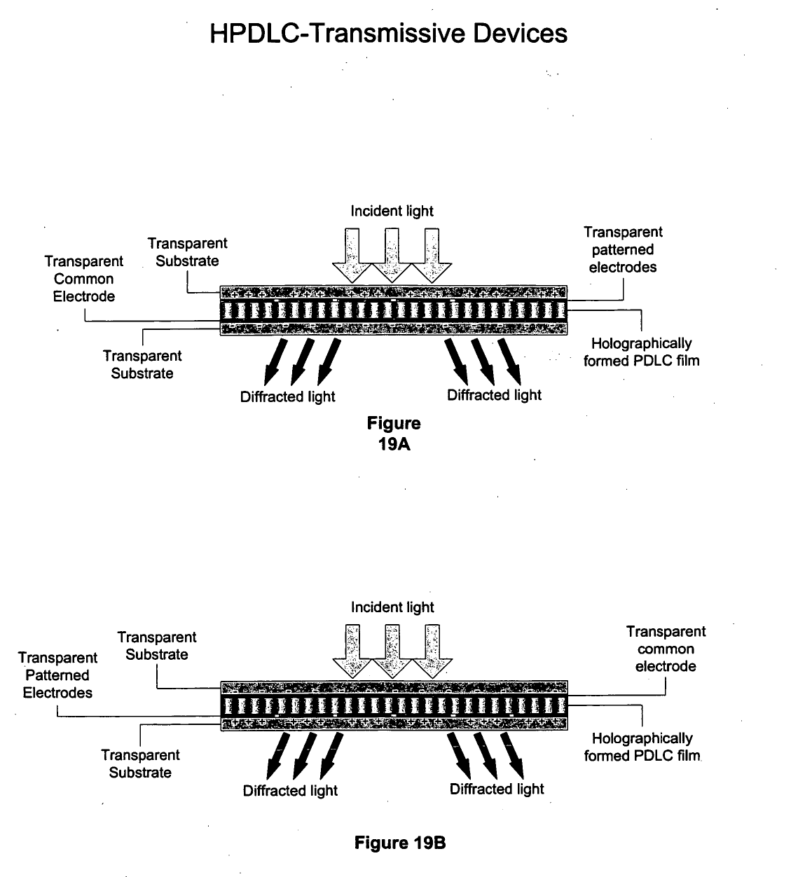

FIGS. 19A-25A are cross sectional views of electronically controlled volume phase grating devices according to various embodiments of the present invention. These embodiments now will be described in detail. Fabrication technologies and device operation then will be described. In these figures, the plus (+) and minus (−) signs indicate relative voltages. For example, in some embodiments the common electrode is grounded and positive and negative voltages ±V are applied to the patterned electrodes. Moreover, in these figures, a single electrode, also referred to as a pixilated electrode, spans between about 4 and about 10 grating periods. However, other numbers of grating periods greater than two may be used.

Referring to FIGS. 19A and 19B, HPDLC-Transmissive Devices are shown. As shown in FIGS. 19A and 19B, Holographically formed PDLC (HPDLC) films are used. HPDLC films are well known to those having skill in the art and the fabrication thereof is well known to those having skill in the art. In general, HPDLC films are formed by developing a polymer film having liquid crystals dispersed therein in the presence of an interference pattern so that the film separates into bands of the polymer and the liquid crystal. As shown in FIG. 19A, the bands extend orthogonal to the substrate. In transmissive devices, an HPDLC film, a transparent common electrode and a transparent patterned electrode are provided between two transparent substrates. As shown in FIGS. 19A and 19B, the orientation of the common electrode and the patterned electrodes may be reversed.

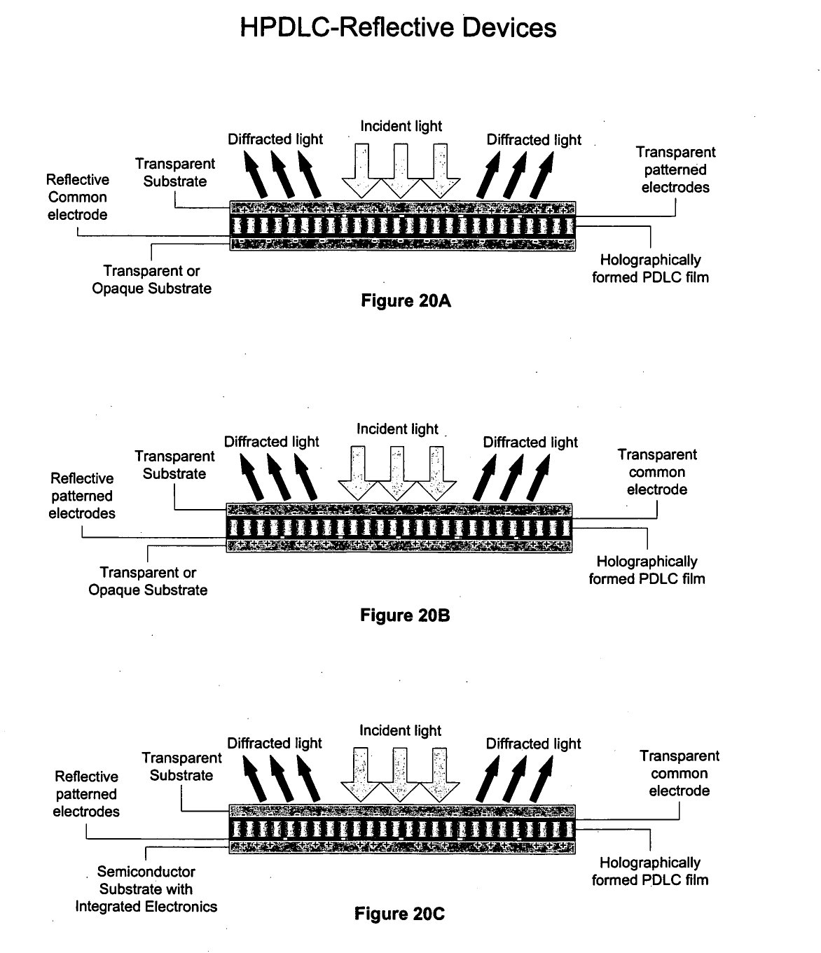

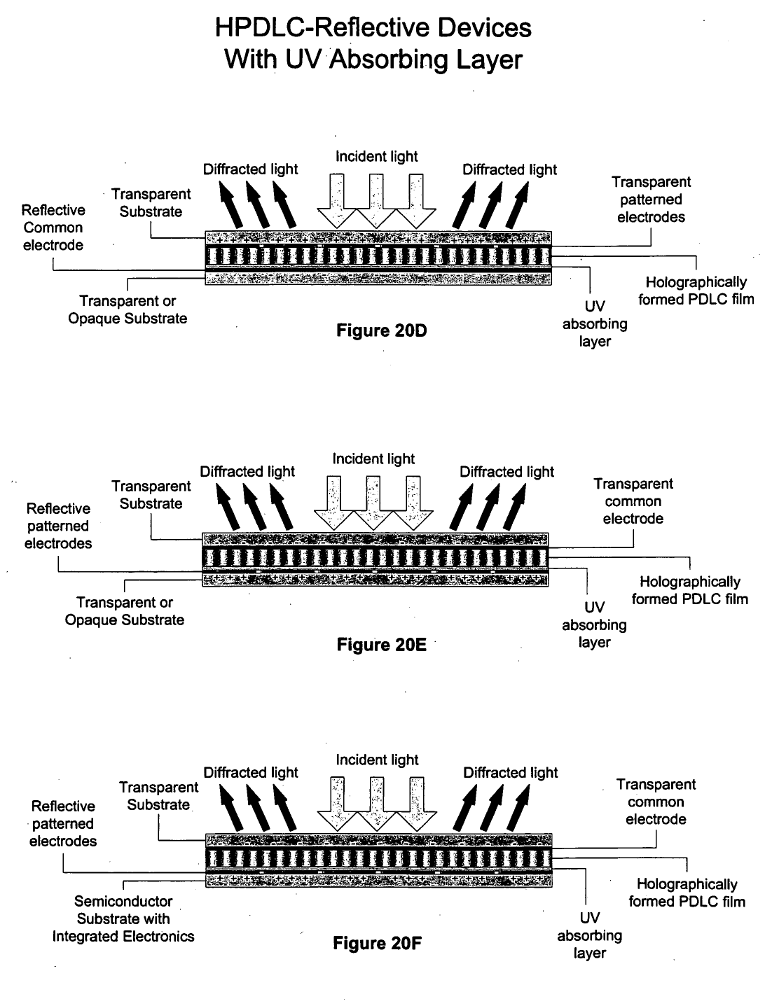

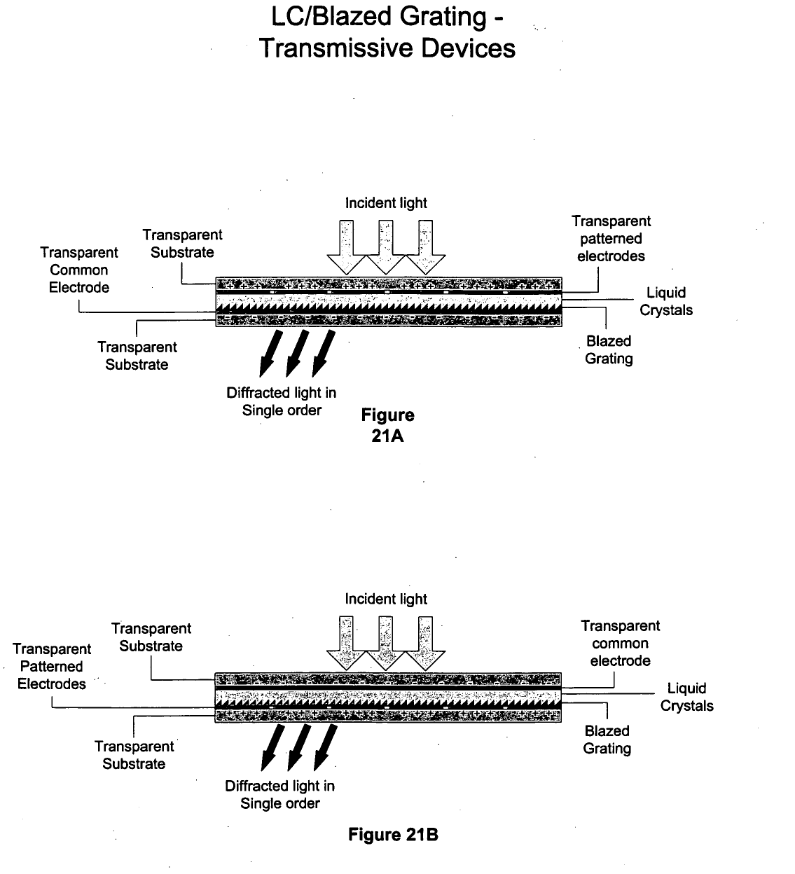

FIGS. 20A-20F are cross sectional views of embodiments of reflective devices that use HPDLC films. As shown in FIGS. 20A and 20B, the bottom electrode (i.e. remote from the incident light) is made reflective. In other embodiments, a transparent electrode and a separate reflective layer may be provided. The reflective electrode can be a common electrode (FIG. 20A) or a patterned electrode (FIG. 20B). In FIG. 20C, either of the embodiments of FIGS. 20A and 20B may be fabricated on a semiconductor substrate with integrated electronics. The same may be true of any other embodiments of the present invention. In FIGS. 20D-20F, a UV absorbing layer is used to allow for a desired UV holographic exposure on a reflective surface. The UV absorbing layer reduces or prevents unwanted back-reflections throughout the HPDLC material and may be used to provide a desired exposure on a reflective surface.

FIGS. 21A and 21B illustrate devices with Liquid Crystal films and Blazed Gratings (LCBG). As is well known to those having skill in the art, blazed diffractive gratings have unequal sides. As shown in FIGS. 21A and 21B, the placement of the common electrode and the patterned electrode may be reversed.

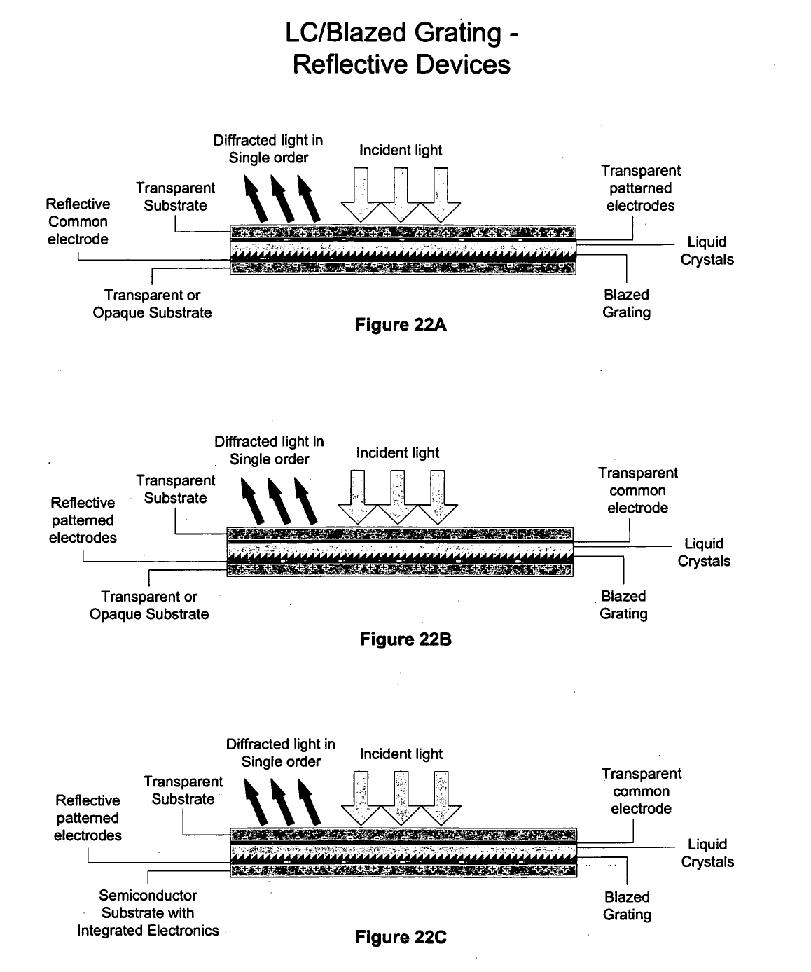

FIGS. 22A-22C illustrate reflective devices that use liquid crystals and blazed gratings. As shown in FIGS. 22A and 22B, the positions of the common electrodes and the patterned electrodes may be reversed. As shown in FIG. 22C, a semiconductor substrate may be used so that integrated electronics may be provided.

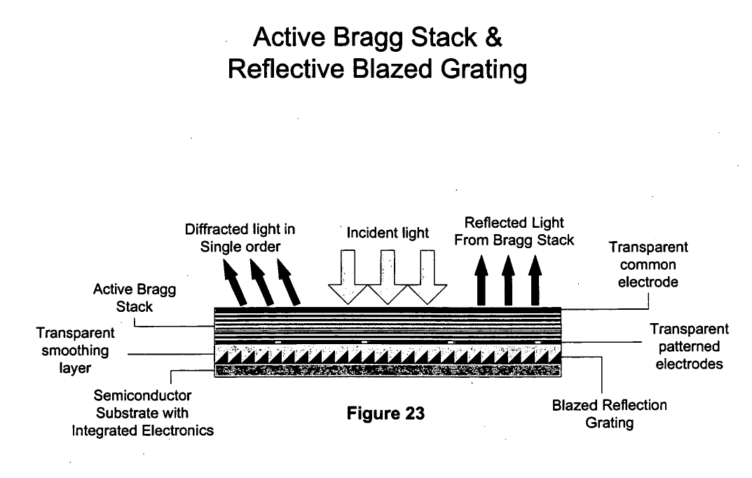

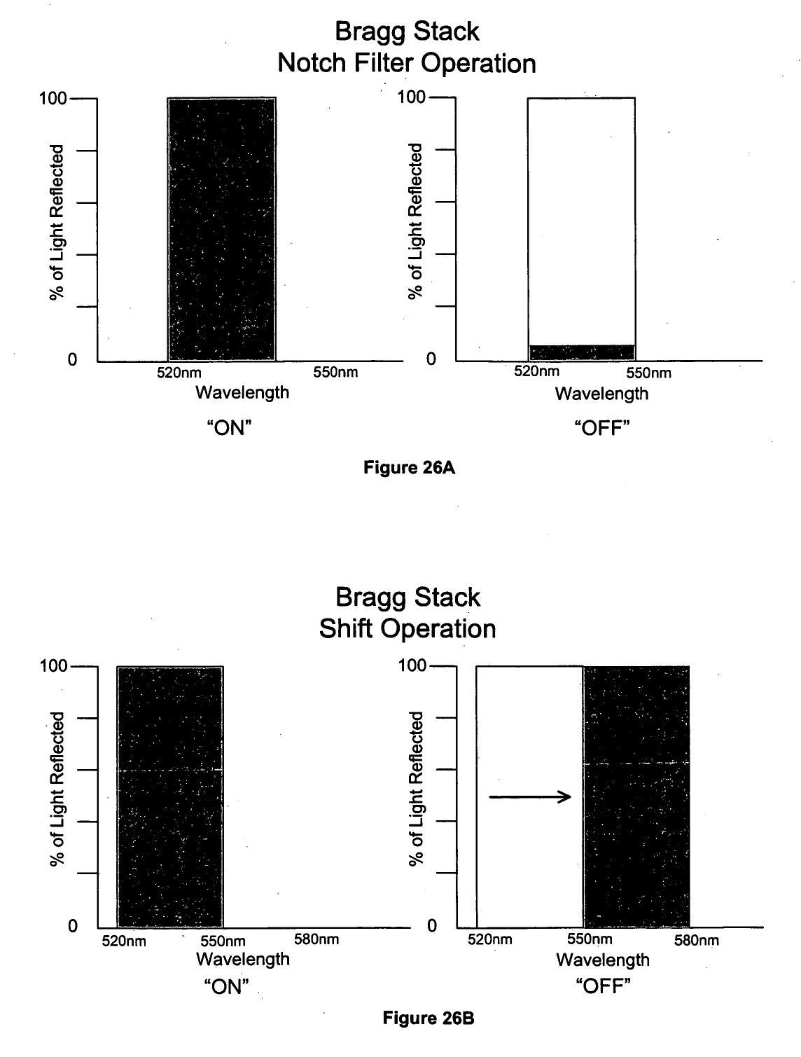

FIG. 23 illustrates embodiments of the invention wherein an active Bragg stack and a reflective blazed grating are used. Active Bragg stacks are well known to those having skill in the art. FIGS. 26A and 26B illustrate how a Bragg stack may be used as a wavelength-selective notch filter and as a wavelength shifter, respectively, in various embodiments of the present invention. These modes of operation of a Bragg stack are well known to those having skill in the art. In FIG. 23, a semiconductor substrate with integrated electronics may be used. However, in other embodiments, integrated electronics need not be used. An HPDLC film may be used in place of or in addition to the active Bragg stack.

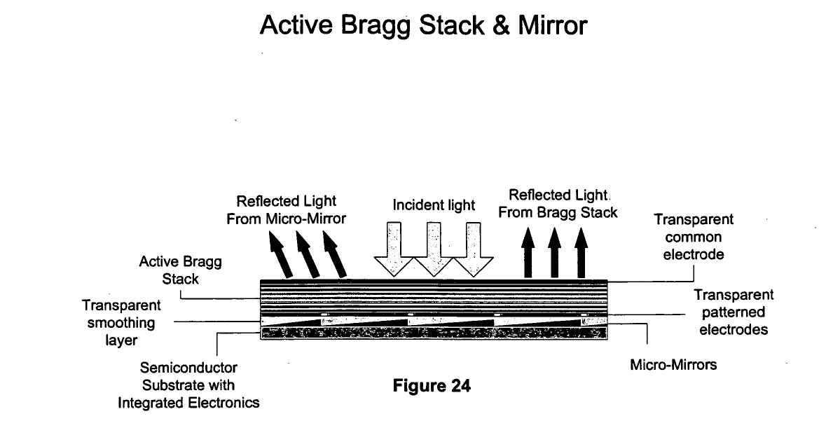

FIG. 24 illustrates other embodiments wherein an active Bragg stack and an array of fixed micro-mirrors are used. Micro-mirrors may be fabricated using dimensional microelectronic fabrication devices as will be described below. An HPDLC film may be used in place of or in addition to the active Bragg stack.

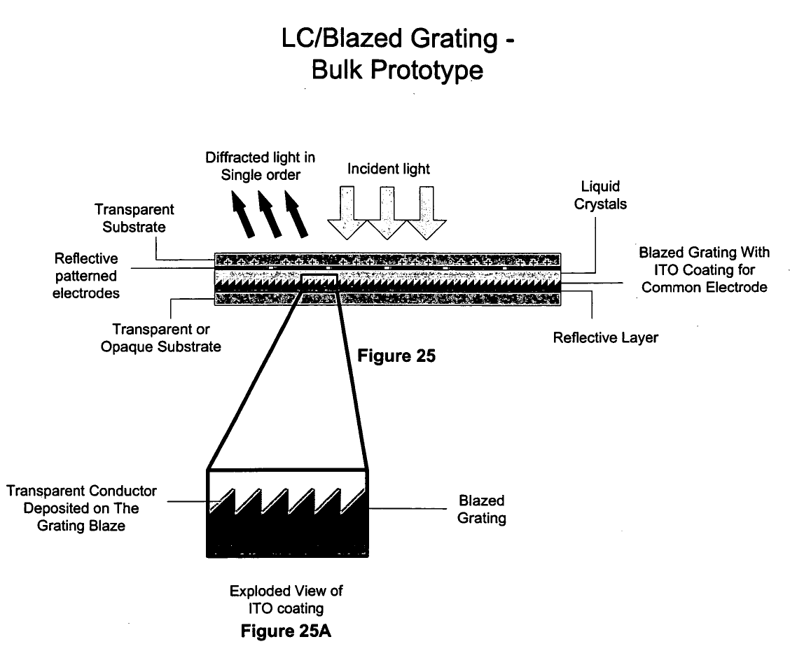

FIG. 25 illustrates other embodiments that employ liquid crystals and blazed gratings (LCBG) wherein the blazed grating is provided with a transparent electrode coating for its common electrode as shown in the exploded view of FIG. 25A. The reflective layer is optional. Transmissive devices may be provided in other embodiments of the invention.

Additional details of embodiments of FIGS. 19-25 now will be provided according to various embodiments of the present invention. In all of these embodiments, the reflective electrodes can comprise platinum, aluminum, nickel and/or any reflective material that is conductive. The transparent electrodes can comprise Indium Tin Oxide (ITO), Cadmium Tin Oxide (CTO) and/or any other transparent conductive material (this includes conductive polymers). In addition, amorphous silicon transistors, such as are fabricated in conventional LCD displays, may be used in place of pixilated (patterned) electrodes. The electrodes may be fabricated using conventional techniques such as sputtering for the common electrodes, deep ultraviolet and other photolithography processes for patterned electrodes and other standard LCD and/or semiconductor processing steps including wet etching, dry etching and/or chemical vapor deposition. The pixel electrodes can vary in size, with various shapes and configurations depending on application. Typical thickness of the electrodes may be about 0.1 μm with ITO.

The substrates can include glass or quartz, which may be inexpensive, can be processed in large sheets and can be used for transparent or reflective devices. Saphire may be used for small devices where cost may not be as important. Semiconductor substrates also may be used such as Silicon, Gallium Arsenide, Indium Phosphide, Silicon Germanium, Gallium Nitride, etc. to allow for integrated electronics and/or driver circuitry.

HPDLC thin films of FIGS. 19 and 20 may be Acrylate based Thiol-Ene based and/or may use other conventional materials. They may be fabricated by holographic UV exposure and curing, continuous wave UV laser with standard exposure and/or pulsed UV laser with phase mask. The HPDLC film thickness may depend on multiple variables. In some embodiments, the film should be thick enough to allow diffraction to occur in the Bragg regime. This may be dependent on grating period and wavelength of the incident light and/or the voltage characteristics of the HPDLC material. In some embodiments, the minimum thickness can range for 630 nm light from about 0.6 μm (grating period about 0.5 μm) to about 20 μm (grating period about 2 μm). Film thickness may be dependent on the voltage that is applied. The maximum thickness may be dependent on grating overmodulation. The voltages that are used for operation may be dependent on the voltage coefficient for the HPDLC and can range from about 10 volts peak to peak to about 200 volts peak to peak depending on whether the grating is turned on, off, or somewhere in between. In some embodiments, a UV absorbing layer is used to reduce or prevent back-reflections during exposure and curing.

Liquid crystal blazed grating devices of FIGS. 21-22 and 25 can use TN (twisted nematic), STN (super twisted nematic), FLC (ferroelectric liquid crystals) and/or other conventional liquid crystal materials. Transmissive blazed gratings may be stamped in optical resin, polyimide, PMMA, conductive polymers, etc. and/or etched according to conventional techniques. The voltage for operation may be dependent on the voltage coefficient for the liquid crystal used and can range from about 3 volts peak to peak to around 20 volts peak to peak.

Devices that use an active Bragg stack and reflective blazed gratings, such as devices of FIG. 23, can use one of three or more possible types of active Bragg stacks: In the first type, alternating layers of active and passive materials are provided. Operation is such that the active material index can be varied with voltage to either match the refractive index of the passive layers or create a shift in index. This provides an on/off type of operation. (See FIG. 26A). In other embodiments, alternating layers of active materials with different refractive indices are provided. This can allow the voltage to shift the index of both materials. This operation can cause a shift in the range of reflected wavelengths. (See FIG. 26B) Finally, a reflective HPDLC can be used instead of or in addition to the active Bragg stack of FIGS. 23 and/or 24. When the device is in the off or shifted mode, the light passes through the Bragg stack and is diffracted off the reflective blazed grating.

The active materials of the Bragg stack can include nonlinear electro-optic materials such as SBN, Lithium Niobate, Gallium Nitride, Aluminum Gallium Nitride, etc. Other active materials that can be used include transition metal oxides, such as Vanadium Dioxide, as well as any other materials that exhibit an electro-optic/electro-chromic property of change in refractive index with applied voltage. The passive materials can include PMMA, polyimide, glass, etc. The design and fabrication of Bragg stacks are well known to those having skill in the art.

When a reflective blazed grating is used without liquid crystals as in FIG. 23, a transparent smoothing layer may be used. The transparent smoothing layer can comprise spin on glass, PMMA, conductive polymer, etc. A reflective blazed grating of FIG. 23 may be fabricated using stamped optical resin, polyimide, PMMA, conductive polymer, etc. with a reflective coating. Etched gratings also may be formed in a semiconductor substrate. The operational voltages may be dependent on the voltage coefficient for the active materials used in the Bragg stack and can range from about 3 volts peak to peak to about 100 volts peak to peak.

In HPDLC thin film devices of FIGS. 19 and/or 20, HPDLC thin films may be fabricated by starting from a conventional prepolymer syrup precursor that contains a mixture of monomers and liquid crystals. This prepolymer syrup is then placed between the two substrates, for example using a backfilling procedure, and placed in a UV light exposure setup. This setup can provide an interference pattern that is shown across the HPDLC films of FIGS. 19 and 20. Where there are bright areas of exposure, polymerization occurs and the monomer shrinks into a polymer. This polymerization causes the liquid crystal to be squeezed out of the polymerized regions and into the dark regions. This produces a phase grating of alternating layers of polymer and liquid crystal. The device may then be cured by flooding with UV light, causing any remaining monomer to polymerize. A sealant then may be placed around the edges to protect the device from moisture and the elements.

Operation of HPDLC devices of FIGS. 19 and 20 may be as follows: Liquid crystals typically have two indices of refraction, depending on the orientation of the crystals. In the “off” state the liquid crystals are in a random orientation which provides a difference in refractive index between the polymer and the liquid crystals. This provides a holographic diffraction grating that can diffract up to about 98% of the light into higher orders. In contrast, in the “on” state, the liquid crystals have an AC voltage placed across them that aligns them so that the refractive index now matches the polymer and the grating substantially disappears. Light is therefore either diffracted into the direction of the diffracted orders (“off”) or it is reflected like a mirror at an angle equal to the incident angle (“on”). High diffraction efficiency thereby may be attained which may be useful for laser based or highly polarized light sources. For example, HPDLC reflective devices can be around 3 or more times more efficient than LCOS devices. Relatively high voltages may be used, and HPDLC devices may not be as desirable for use with unpolarized light sources.

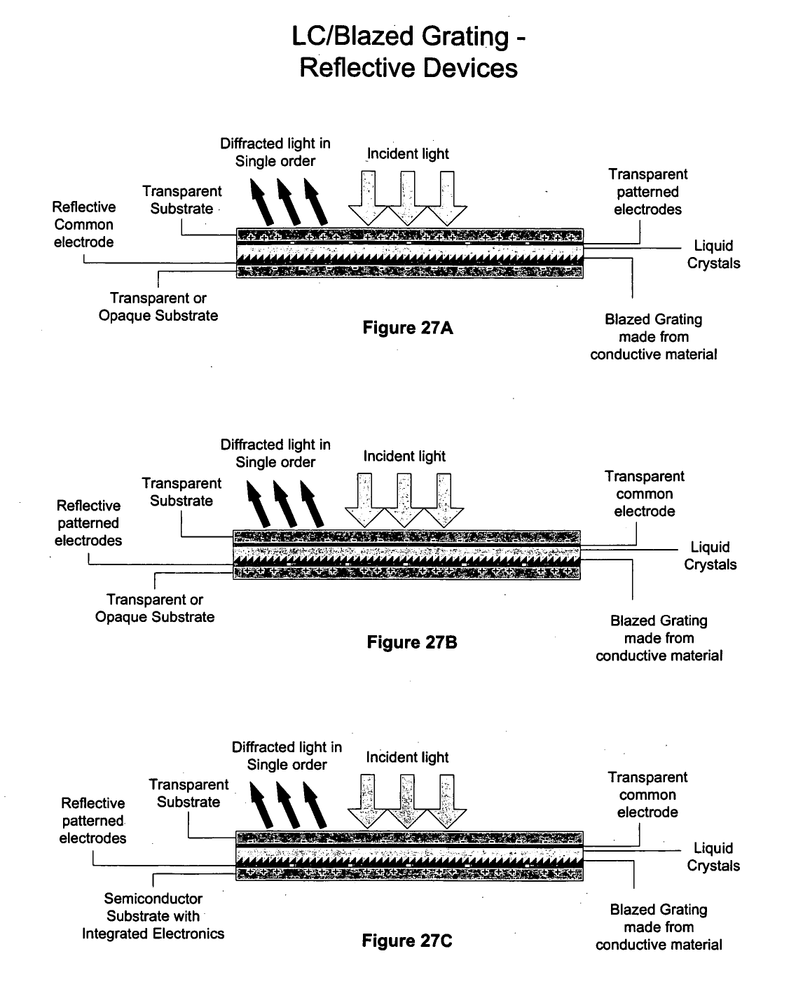

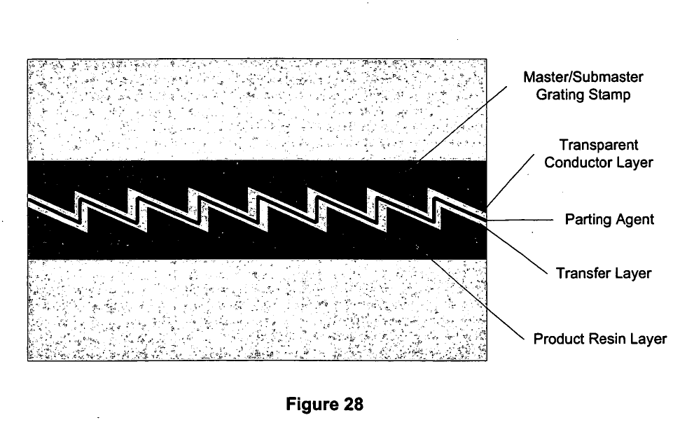

Liquid crystal blazed grating devices of FIGS. 21, 22 and 25, may be fabricated by placing a transmission blazed grating on a substrate with a conductive layer underneath that can be pixilated, and reflective or transparent as shown in these figures. This grating can be fabricated in several conventional ways. It can be formed through a nano-stamped process (nano-imprinting) that imprints the grating in an optical resin, polyimide, PMMA, conductive polymer (see FIG. 27), etc. The gratings that are formed from a non-conductive material and that do not utilize a conductor underneath, can have a transparent conductor placed on top through various methods. These methods include sputtering, deep ultraviolet and other photolithography processes including wet etching, dry etching and/or chemical vapor deposition. Another method is to include ITO, CTO and/or any other transparent conductive material as part of the grating imprinting step. This method includes using a master or submaster grating with a release layer and a transfer coating made of a transparent conductor in place of the traditional transfer coatings (FIG. 28). It can also be etched out of a transparent material. Other techniques may be used. Another substrate with a transparent electrode, such as ITO, that is either pixilated or is in a common ground is provided with an alignment layer setup on the surface. The two substrates are then placed opposite each other and then gapped and sealed on three sides. Liquid crystals are then backfilled into the device and then it is sealed with optical adhesive.

Operation of LC/BG devices of FIGS. 21, 22 and 25 now will be described. Liquid crystals typically have two indices of refraction depending on the orientation of the crystals. In the “off” state the liquid crystals are in an orientation due to the alignment layer and the grating which gives a difference in refractive index between the grating and the liquid crystals. This provides a blazed diffraction grating that can diffract up to about 75% of the light into a single order. This can be obtained for all polarizations. Therefore, unpolarized light may be used.

In the “on” state, the liquid crystals have an AC voltage placed across them that aligns them so that the refractive index now matches the grating and the grating can substantially disappear. Light is either diffracted into the direction of a diffracted order (“off) or it is reflected like a mirror at an angle equal to the incident angle (“on”). Accordingly, high diffraction efficiency in s and p polarizations may be obtained, which can be used with LED-based or unpolarized light sources. These devices may be up to 3-5 or more times more efficient than LCOS devices. However, they may be slower than MEMs devices and they may be less desirable for use with polarized light sources.

Embodiments of the present invention that use an active Bragg stack and a reflective blazed grating, as shown in FIG. 23 may be fabricated by placing a reflective blazed grating on a substrate that may or may not be pixilated. This grating can be fabricated in several conventional ways. It can be formed through a nano-stamped process (nano-imprinting) with a reflective layer applied to it. It can also be etched out of a material such as silicon to form a blazed grating and then coated with a reflective layer. A transparent material is then used to fill in the valleys of the grating to form a smooth surface. Transparent electrodes are then placed on this layer to form a pixilated surface. An active Bragg stack is then placed on the transparent electrodes to provide a switchable mirror.

Operation of devices of FIG. 23 now will be described. In the “off” state, the Bragg stack acts like a mirror and the light is reflected at an angle equal to the incident angle. It is tuned to the wavelength used in the device (for example, RGB). In contrast, in the “on” state, the Bragg stack shifts (FIG. 26B) or disappears (FIG. 26A) depending on the type used, and light passes through to the grating. This grating can diffract up to about 90% of the light into a single order and may be used for all polarizations, with unpolarized light. Accordingly, high diffraction efficiency may be obtained in both s and p polarizations, which may be used with LED-based or unpolarized light sources. About 3-6 times higher efficiency than LCOS devices may be obtained. Faster operation may be obtained than with MEMs devices because no liquid crystals or moving parts may be needed. These devices may be used in telecom applications because they may be integrated with semiconductor processes. However, the voltages may be relatively high and there may be a minimum pixel size due to the grating.

Active Bragg stack and micro-mirror devices as illustrated in FIG. 24 may be fabricated by placing a repeating micro-mirror on a substrate that may or may not be pixilated. This grating can be fabricated in several conventional ways. It can be formed through nano-imprinting with a reflective layer applied to it. It can also be etched out of a material such as silicon to form a valley and then coated with a reflective layer to give a mirrored surface. Other conventional techniques may be used. A transparent material is then used to fill in the valleys of the mirrored surface to form a smooth surface. Transparent electrodes are then placed on this layer to form a pixilated surface. An active Bragg stack is then placed on the transparent electrodes to provide a switchable mirror.

Operation of devices of FIG. 24 now will be described. In the “off” state, the Bragg stack acts like a mirror and the light is reflected at an angle equal to the incident angle. It is tuned to the wavelength used in the device (for example, RGB). In the “on” state, the Bragg stack substantially disappears and the light passes through to the micro-mirror array. These micro-mirrors can reflect up to about 90% of the light into a different direction. Micro-mirrors may be used for any polarization so that polarized or unpolarized light may be used. Accordingly, high reflection may be obtained which may be used with LED-based or unpolarized light sources. About 3-6 times more efficiency than LCOS devices may be obtained. No moving parts are present and liquid crystals are not used so that faster devices than conventional MEMs devices may be obtained. Integrated electronics can allow use in Telecom or other applications. These devices may have pixel sizes that are very scalable. High voltages may be used.

In the drawings and specification, there have been disclosed embodiments of the invention and, although specific terms are employed, they are used in a generic and descriptive sense only and not for purposes of limitation, the scope of the invention being set forth in the following claim(s).

1. An electronically controlled volume phase grating device comprising:
a transparent substrate and a semiconductor substrate with integrated electronics in closely spaced-apart relation;
a common electrode and patterned electrodes in closely spaced-apart relation between the transparent substrate and the semiconductor substrate; and
a blazed grating and a liquid crystal film between the common electrode and the patterned electrodes.
